(19) United States
(12) Patent Application Publication
(10) Pub. No.: US 2007/0208661 A1
(43) Pub. Date: Sep. 6, 2007

(54) Method for home buyer loan approval process validation

(76) Inventor: William Moran, Thousand Oaks, CA (US)

Correspondence Address: FULBRIGHT AND JAWORSKI LLP, 555 S. FLOWER STREET, 41ST FLOOR, LOS ANGELES, CA, 90071, US

(21) Appl. No.: 11/710,120

(22) Filed: Feb. 22, 2007

Related U.S. Application Data
(60) Provisional application No. 60/776,167, filed on Feb. 22, 2006.

(51) Int. Cl. G06Q 40/00

(52) U.S. Cl. 705/38

(57) ABSTRACT

A method for receiving and verifying information received from a prospective home buyer and providing an indicia to the home buyer of loan approval. Such indicia is then used by the home buyer in soliciting property to purchase and in obtaining a final loan for purchase of the selected property.

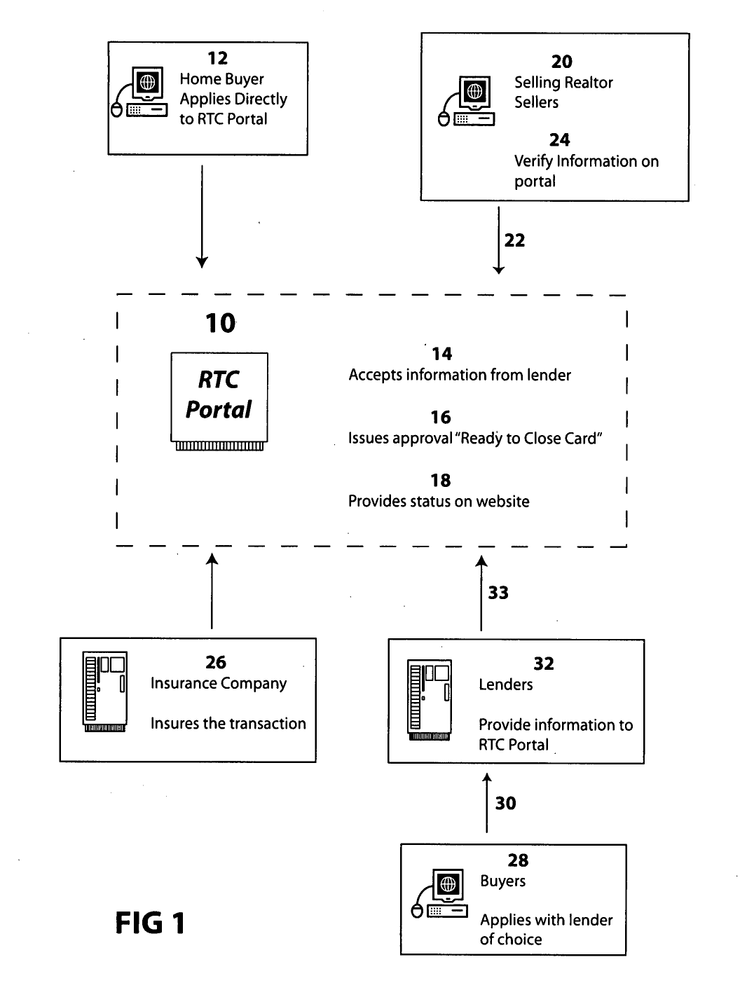

### RELATED APPLICATION

This application claims the benefit of the prior filing date of U.S. Provisional Patent Application No. 60/776,167 filed Feb. 22, 2006 for Method for Home Buyer Loan Approval Process Validation, incorporated herein by reference in its entirety.

### FIELD OF THE INVENTION

The present invention relates generally to the real estate market and more particularly to a method by which a Home Buyer's eligibility to obtain required financing can be validated.

### BACKGROUND OF THE INVENTION

In almost all cases, a buyer of a home must normally obtain a mortgage on the home in order to purchase the same.

Traditionally Home Buyers find a home they like, obtain an accepted offer, then go to their mortgage lender, apply for a loan and hope to be approved. Over the last five years or so many lenders have been offering to “pre-qualify” or “pre-approve” potential Home Buyers before they start making offers on homes. Realtors who represent Home Buyers also often suggest to the buyer they are working with in finding a home that they get “pre-qualified” or “pre-approved.”

Home Buyers often obtain an accepted offer with a contingency to obtain a written loan commitment within a certain time frame. Sellers want to avoid taking their home off the market only to find out the Home Buyer can not qualify for the new loan needed to complete the purchase. So they ask to see that the buyer has been pre-qualified or approved. In addition sellers will ask to see a Home Buyer's credit report and or ask how much they are putting as down payment towards their purchase. This information provides a false sense of security to a seller, and often is discriminatory to someone with less than perfect credit or who is putting little or nothing down, which has become common in recent years. Sellers often feel more secure with someone who is making a large down payment or has excellent credit. This often isn't reliable. In the height of the recent real estate boom many qualified buyers were unable to purchase a home because sellers were receiving multiple offers and would often accept the offer from the buyer making a larger down payment.

The terms “Pre-qualified” and “Pre-approved” are subjective terms and don't serve any real purpose other than to tell the interested parties that the potential Home Buyers have spoken with a mortgage lender and that lender said they will qualify. In theory the pre-qualify and approval process is designed to perform a review of a loan application submitted by the Home Buyer. The person doing the pre-qualifying process supposedly reviews the credit as well as other documentation needed with the obvious exception of the property appraisal. The problem is no one knows exactly what steps the Home Buyer has taken and how close the mortgage lender reviewed the Home Buyer's documentation and what other steps were taken before issuing the pre-qualify or approval letter. Often times these letters are typed up after only a casual conversation with a Home Buyer and no document reviews are done at all. To be accurate, the approval process involves the packaging of all required documents and then presentation to an underwriter to make a final determination as to qualification for the particular loan program the borrower has requested.

In recent years the advent of computer automated underwriting has replaced the manual decision making of an underwriter. Data is now input into a rules based computer program, which validates data entered against the guidelines of loan programs. The loan is then either approved or declined. An underwriter then simply has to verify the documents supplied by the borrower against the data entered into the automated underwriting system.

Currently there are several major underwriting systems used in the lending industry. Fannie Mae, the largest purchaser of single family residential home loans, offers the most common such system called Desktop Underwriter or DU. Fannie Mae sets the standard for much of the lending industry. One such example is the standard application of all lenders require today is a Fannie Mae Form 1003. Many lenders use the DU system even if the loan is not going to be sold to Fannie Mae. Freddie Mac offers the Loan Prospector application.

In addition to these underwriting systems, most major lenders allow for on-line status of loans that have been submitted to them for funding. After loans are approved through the automated underwriting system documentation that supports the information entered into the AUS is sent to the underwriter who reviews it for accuracy. When the documents have been accepted the status of the loan is reflected back onto the lenders website.

Problems with current system:

Was a complete application taken or did the lender base their decision on verbal information provided by the Home Buyer?

Has the loan been entered into an Automated Underwriting System (AUS)?

Has an underwriter verified the supporting documentation?

Was the credit report reviewed?

Was the information on the application verified?

Currently there is no way for an interested party, in particular a seller or his representative, to know these things except task for a letter from the potential lender. It's not uncommon for lenders to issue these letters without actually verifying all the pertinent information from a borrower or entering the loan into an automated underwriting system.

The present invention provides a means to verify that a borrower has indeed applied for a loan and that the application has been entered into an automated underwriting system. This would be accomplished by the application server connecting with the appropriate automated underwriting system and returning the status of the borrowers loan. This will allow concerned parties to verify that the borrower has indeed applied for a loan and the status of that loan.

### SUMMARY OF THE INVENTION

The method of verifying the loan approval for a purchaser of a home comprising the steps of obtaining documentation from the purchaser relating to the information required by a lender to process a loan; entering the documentation into an automated underwriting system; processing the information and issuing to the purchaser an indicia signifying approval of the loan.

### BRIEF DESCRIPTION OF THE DRAWING

The drawing represents, generally in block form, a system for carrying out the method of present invention.

### DETAILED DESCRIPTION OF THE INVENTION

The overall purpose of the present invention is to provide to the Home Buyer an indicia which for purposes of this description will be referred to as a Ready-To-Close Card or RTC Card which the Home Buyer can present to a seller or a seller's representative. The RTC Card is an indicia signifying to the seller or the seller's representative that the Home Buyer has gone through a bona fide loan approval process and has been approved for a pre-determined loan amount and so long as the loan required to purchase the home, is within that approved amount, the Home Buyer is in a condition such that the transaction of the sale and purchase of the home is in a condition where it is “ready to close.”

As is illustrated in the drawing, there is provided a RTC Portal 10. The Portal 10 is designed to accept information from the Home Buyer. As is indicated at 12, the Home Buyer may apply directly to the RTC Portal for approval of a loan of a pre-determined amount to be used to purchase a home. In making this application, the Home Buyer provides data of the type normally required for loan approval. Such data would be typically name, address, social security number, marital status, employment information, income and monthly expense information as well as a description of asset and liabilities. The RTC Portal also requests backup information to validate data provided by the home buyer, such for example, as W-2 forms, paycheck stubs, tax returns, financial statements and the like. That information would be accepted by the RTC Portal as indicated at 14. The RTC Portal then processes the information, typically by using an AUS, and determines whether or not the loan requested by the Home Buyer is approved or denied, or alternatively, would provide information as to the amount of loan which is approved. When the processing occurs and the approval is issued as illustrated at 16, the RTC Portal issues an RTC Card which can then be utilized by the Home Buyer in the purchase of the home. As is also indicated at 18, the information concerning the RTC Card and the fact that the Home Buyer has been approved for a loan of a pre-determined amount, is then posted on the RTC website, which is a secure website that can then be accessed by authorized individuals.

After the Home Buyer receives the RTC Card, the Home Buyer may then seek out a home which is desirable. The Home Buyer would then negotiate with the seller or the realtor representing the seller as indicated at 20 to purchase the home. As part of the negotiating process, the Home Buyer would present the RTC Card to the seller or the seller's realtor, agent or other representative indicating the Home Buyer is in a “ready to close” situation. The seller or the seller's representative may then access the RTC website as shown at 22 for the purpose of verifying the information represented on the RTC Card as is illustrated at 24. It is contemplated that the seller's representative will have registered with the RTC Portal and received an appropriate password to access and log on to the website.

As part of the overall process, an insurance company 26 may be involved in processing the Home Buyer's application for the RTC Card. The insurance company will, upon the information provided by the Home Buyer being appropriately processed, validated and approved, and the RTC Card being approved, insure the transaction so that any seller or seller's representative will have complete assurance that the transaction as negotiated between the Home Buyer and the seller will be closed, since the loan amount referenced on the RTC Card is effectively guaranteed by the insurance company 26.

As an alternative to the Home Buyer accessing the RTC Portal and applying directly for the RTC Card, the Home Buyer may go to a lender of the Home Buyer's choice as shown at 28, 30 and 32 and make application for a loan. The lender would then obtain the information as above discussed required to process the loan. The information required would be that as referred to, for example, on Fannie Mae Form 1003 or Freddie Mac Form 65, Universal Residential Loan Application which are the same. Such loan applications are readily available and by this reference are incorporated herein. Alternatively, the lender may have its own residential loan application for use in such a transaction. In any event, once the information is obtained, it is transmitted as shown at 33 to the RTC Portal. There may be a plurality of lenders that the Home Buyer may approach, each of which would have access to the RTC Portal. Typically such lenders must register with the RTC Portal and have received an appropriate password to be able to obtain access to it and log on for the purpose of obtaining an RTC Card for Home Buyers who make application to the lenders. Once the information is submitted, the RTC Portal processes the information as above described, and if the loan application is approved, would issue the RTC Card as shown at 16, which could then be used by the Home Buyer to approach the seller or the seller's representatives as above described.

In should be recognized by those skilled in the art that the RTC Portal would include a typical website and would have appropriate automatic underwriting system processing which would be utilized to process the loan information and determine whether or not appropriate approval is warranted so that the RTC Card could be issued.

What is claimed is:

1. The method of providing indicia indicative of an approved loan amount comprising the steps of:
providing a portal containing appropriate automated underwriting capability for processing a loan application;
providing access to the portal by a prospective home buyer;
providing means for the home buyer to submit to the portal information required for processing a desired loan amount;
processing the information provided by the purchaser and if approved, issuing an indicia to the home buyer indicative of the fact that the loan amount is ready to close; and
storing the ready to close designation at the portal and providing access to the portal by prospective lenders and brokers for the purpose of allowing verification of the ready to close status of the home buyer.

2. The method as defined in claim 1 which further includes originating lenders registering with the portal;
originating lenders obtaining said home buyer information and submitting said information to said portal for processing.

3. The method as defined in claim 2 wherein said processing step includes submitting said information to an automated underwriting system (AUS).

4. The method as defined in claim 3 which further includes independently verifying the information provided by the home buyer prior to submitting the information to the AUS.

5. The method as defined in claim 4 which further includes seller's representatives registering with the portal, logging onto the portal, and verifying accuracy of the indicia.

6. The method as defined in claim 5 which further includes validation of said information and insuring the loan amount.

7. The method as defined in claim 6 wherein said indicia is a cord for use by the home buyer to show the loan is ready to close.

8. The method as defined in claim 6 wherein said indicia is an entry posted on said portal that can be accessed by seller's representatives.

9. The method as defined in claim 6 wherein said indicia is an entry on said portal that can be accessed by lenders.
